(19) United States
(12) Patent Application Publication
(10) Pub. No.: US 2006/0040164 A1
(43) Pub. Date: Feb. 23, 2006

(54) Surface modifications of fuel cell elements for improved water management

(75) Inventors: Gayatri Vyas, Rochester Hills, MI (US); Richard H. Blunk, Macomb, MI (US); Martin S. Kramer, Clarkston, MI (US); Mahmoud H. Abd Elhamid, Grosse Pointe Woods, MI (US); Daniel J. Lisi, Eastpointe, MI (US)

Correspondence Address: Cary W. Brooks;General Motors Corporation Legal Staff, 300 Renaissance Center, MC 482-C23-B21, PO Box 300, Detroit, MI, 48265-3000, US

(73) Assignee: GM Global Technology Operations, Inc., Detroit, MI (US)

(21) Appl. No.: 11/206,565

(22) Filed: Aug. 18, 2005

Related U.S. Application Data
(60) Provisional application No. 60/602,759, filed on Aug. 19, 2004.

(51) Int. Cl. H01M 8/02; B24C 1/00

(52) U.S. Cl. 429/34; 451/38

(57) ABSTRACT

Methods and systems for enhancing water management capabilities of a fuel cell system are described. The method includes blasting of the surface of a bipolar plate to roughen the surface to create a super hydrophilic or super hydrophobic surface for enhanced water management. Preferably water jet blasting is used. Other blasting methods include grit blasting, sand blasting and dry ice blasting.

### CROSS-REFERENCE TO RELATED APPLICATION

The instant application claims priority to U.S. Provisional Patent Application Ser. No. 60/602,759, filed Aug. 19, 2004, the entire specification of which is expressly incorporated herein by reference.

### FIELD OF THE INVENTION

The present invention generally relates to surface modifications of fuel cell elements for improved water management. More specifically, the present invention relates to increasing the surface hydrophilicity or hydrophobicity of the surface of a fuel cell plate using blasting for enhancing water management.

### BACKGROUND OF THE INVENTION

Fuel cells include three components: a cathode, an anode, and an electrolyte that is sandwiched between the cathode and the anode and passes only protons. Each electrode is coated on one side by a catalyst. In operation, the catalyst on the anode splits hydrogen into electrons and protons. The electrons are distributed as electric current from the anode, through a drive motor and then to the cathode, where as the protons migrate from the anode, through the electrolyte to the cathode. The catalyst on the cathode combines the protons with electrons returning from the drive motor and oxygen from the air to form water. Individual fuel cells can be stacked together in a series to generate increasing larger quantities of electricity.

In a Polymer-Electrolyte-Membrane (PEM) fuel cell, a polymer electrode membrane serves as the electrolyte between a cathode and an anode. They polymer electrode membrane currently being used in fuel cell applications requires a certain level of humidity to facilitate proton conductivity. Therefore, maintaining the proper level of humidity in the membrane, through humidity-water management, is desirable for proper functioning of the fuel cell. Irreversible damage to the fuel cell can occur if the membrane dries out.

In order to prevent leakage of the hydrogen gas and oxygen gas supplied to the electrodes and prevent mixing of the gases, a gas sealing material and gaskets are arranged on the periphery of the electrodes, with the polymer electrolyte membrane sandwiched therebetween. The sealing material and gaskets are assembled into a single part together with the electrodes and polymer electrolyte membrane to form a membrane and electrode assembly (MEA). Disposed outside of the MEA, are conductive separator plates for mechanically securing the MEA and electrically connecting adjacent MEAs in series. A portion of the separator plate, which is disposed in contact with the MEA, is provided with a gas passage for supplying hydrogen or oxygen fuel gas to the electrode surface and removing generated water.

The presence of liquid water in automotive fuel cells is unavoidable because appreciable quantities of water are generated as a by-product of the electro-chemical reactions during fuel cell operation. Furthermore, saturation of the fuel cell membranes with water can result from rapid changes in temperature, relative humidity, and operating and shutdown conditions. Excessive membrane hydration may result in flooding, excessive swelling of the membranes and the formation of differential pressure gradients across the fuel cell stack.

Cell performance is influenced by the formation of liquid water or by dehydration of the ionic exchange membrane. Water management and the reactant distribution have a major impact on the performance and durability of fuel cells. Cell degradation with mass transport losses due to poor water management still remains a concern for automotive applications. Long exposure of the membrane to water can also cause irreversible material degradation. Water management strategies such as pressure drop, temperature gradients and counter flow operations have been implemented and been found to reduce mass transport to some extent especially at high current densities. Good water management, however, is still needed for performance and durability of a fuel cell stack.

Accordingly, there exists a need for new and improved fuel cell elements that exhibit improved water management characteristics.

### SUMMARY OF THE INVENTION

In accordance with a first embodiment of the present invention, there is provided a method of modifying the surface of a fuel cell element is provided, comprising: (1) providing a fuel cell element having a surface formed thereon; and (2) roughening the surface of the fuel cell element to create either a super hydrophilic or a super hydrophobic surface thereon.

In accordance with an alternate embodiment of the present invention, a fuel cell system is provided, comprising a fuel cell element having a surface formed thereon, wherein the surface of the fuel cell element has been roughened to create either a super hydrophilic or a super hydrophobic surface thereon.

### BRIEF DESCRIPTION OF THE DRAWINGS

Advantages of the present invention will be more fully appreciated from the detailed description when considered in connection with accompanying drawings of presently preferred embodiments which are given by way of illustration only and are not limiting wherein:

FIG. 1 is a schematic view of a fuel cell, in accordance with the general teachings of the present invention;

FIG. 2 contains the results of a WYKO surface profiler for a roughened sample of stainless steel, in accordance with a first embodiment of the present invention;

FIG. 3 contains the results of a WYKO surface profiler for a smooth or unroughened sample of stainless steel, in accordance with the prior art;

FIG. 4 contains an SEM (i.e., Scanning Electron Microscope) image of a smooth or unroughened sample of stainless steel magnified 1000 times, in accordance with the prior art; and

FIG. 5 contains an SEM image of a roughened sample of stainless steel magnified 1000 times, in accordance with a second embodiment of the invention.

### DETAILED DESCRIPTION OF THE PREFERRED EMBODIMENTS

The following description of the preferred embodiment(s) is merely exemplary in nature and is in no way intended to limit the invention, its application, or uses.

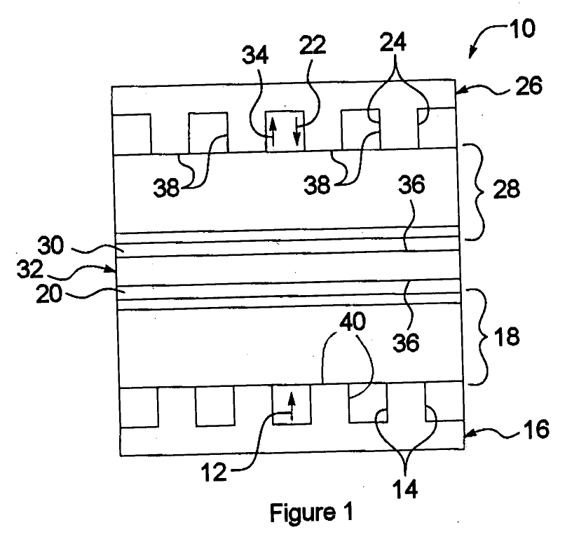

A fuel cell system is generally shown at 10 in FIG. 1. During operation of the fuel cell system 10, hydrogen gas 12 flows through the field flow channels 14 of a bipolar plate generally indicated at 16 and diffuses through the gas diffusion medium 18 to the anode 20. In like manner, oxygen 22 flows through the field flow channels 24 of the bipolar plate generally indicated at 26 and diffuses through the gas diffusion medium 28 to the cathode 30. At the anode 20, the hydrogen 12 is split into electrons and protons. The electrons are distributed as electrical current from the anode 20, through a drive motor (not shown) and then to the cathode 30. The protons migrate from the anode 20, through the PEM generally indicated at 32 to the cathode 30. At the cathode 30, the protons are combined with electrons returning from the drive motor (not shown) and oxygen 22 to form water vapor 34. The water vapor and/or condensed water droplets 34 diffuses from the cathode 30 through the gas diffusion medium 28, into the field flow channels 24 of the bipolar plate 26 and is discharged from the fuel cell stack 10.

During transit of the water vapor/droplets 34 from the cathode 30 to the bipolar plate 26 and beyond, the hydrophilic or hydrophobic bipolar plate surfaces 38, 40, respectively, of the bipolar plates 16, 26, respectively, aid in water management.

Thus, it is well known that in a fuel cell stack at the cathode side, the fuel cell generates water in the catalyst layer. The water must leave the electrode. Typically, the water leaves the electrode through the many channels 24 of the element or bipolar plate 26. Typically, air passes through the channels and pushes the water through the channels 24. A problem that arises is that the water creates a slug in the channels 24 and air cannot get to the electrodes. When this occurs, the catalyst layer near the water slug will not work. When a water slug forms, the catalyst layer near the slug becomes inactive. This condition is sometimes referred to as flooding of the fuel cell. The result of flooding is a voltage drop that creates a low voltage cell in the stack.

A similar phenomenon holds true on the anode side of the cell. On the anode side of the cell, hydrogen can push the water through the channels 14 of the element or bipolar plate 16.

Often times, when a voltage drop occurs, the voltage drop continues to worsen. When one of the channels 14, 24, respectively, in the plate 16, 26, respectively, becomes clogged, the oxygen or hydrogen flow rate passing through the other channels in other cells within the same stack increases. Eventually, the fuel cell saturates with water and may flood. Because the stack is connected electrically in series, eventually the whole fuel cell stack may flood with water and shut down. Accordingly, it is desirable to improve the water management properties of the bipolar plates to enhance stack performance and durability and eliminate low performance cells.

One attempt to solve the problem has been to increase the velocity of the reactive gases, air on one side or hydrogen on the other, to force the water through the channels. However, this is an inefficient method for clearing the water from the channels and is not cost effective.

According to one embodiment of the present invention, the surfaces 38, 40, respectively, of the fuel cell elements or bipolar plates 16, 26, respectively, are modified to improve water management. More specifically, the surfaces 38, 40, respectively, of the bipolar plates 16, 26, respectively, are modified to form create super hydrophilic and super hydrophobic surfaces. Super hydrophilic surfaces on fuel cell bipolar plates are desirable for improving water management and thus increasing fuel cell efficiency. Likewise, super hydrophobic surfaces are desirable for improving water management, thus increasing fuel cell efficiency. A super hydrophilic or super hydrophobic surface helps wick water through the channels 14, 24, respectively. This aids in preventing water slug formation in the channels 14, 24, respectively.

According to one embodiment of the present invention, water jet blasting is used to roughen the surface of metal and polymers on the surface of the fuel cell bipolar plate. This roughness occurs at the nanometer and micrometer length scale. The high surface area created by water jet blasting on the surfaces of the metals and polymers can increase hydrophilicity of the bipolar plate surfaces and thus form a thin film of water to promote water transport.

The wettability of a surface can be manipulated directly by the surface properties, especially by roughening the surface. The wettability of smooth, hydrophilic surfaces is improved by roughening them. The contrary affect is observed with smooth hydrophobic surfaces. By roughing the surface, the contact angle will increase. The effect of roughness on water movement has been known. Wetting phenomena have been studied in theories and experiments. The Young's equation describes the classic contact Θ of a drop on an ideal flat homogeneous surface as: γlv cosΘ=γsv−γsl, (1) where γlv, γsv and γsl are the surface tensions or surface energies of the liquid/vapor, solid/vapor and solid/liquid phase interfaces.

A model to characterize of the influence of the surface roughness on the wettability of a solid was proposed by Wenzel. In that model, the apparent contact angle Θ on a rough surface can be evaluated by considering a small displacement of the contact line parallel to the surface, where r is the solid roughness, (ration between the real surface and the projected ones). The equilibrium is given by the minimum of F, which results in Wenzel's law: cos Θ_{w}=sr cos Θ γ, where Θ is the contact angle given in Eq. (1). The ratio between the real surface and the projected ones is always greater than one r>1, therefore the wettability increases i.e. roughening improves wetting for wetting liquids (e.g., contact angle<90), but degrades wetting for non-wetting liquids (e.g., contact angle>90).

The use of water jet blasting roughens the surface of metals and polymers on the fuel cell bipolar plate. In one example, water jet samples were analyzed to measure the surface roughness using WYKO Surface Profilers from WYKO Corp. (Tucson, Ariz.). WYKO surface profiler systems are non-contact optical profilers that use optical interferometric techniques to measure the topographic features of smooth and rough surfaces. In this, a white light beam passes through a red narrow band filter and through a microscope objective to the sample surface. A beam splitter reflects half of the incident beam to the reference surface. The beam reflected from the sample and the reference recombines at the beam splitter to form interference fringes. The system records the intensity of resulting interference pattern at different relative phase shifts and then converts the intensity of phase data by integrating the intensity data.

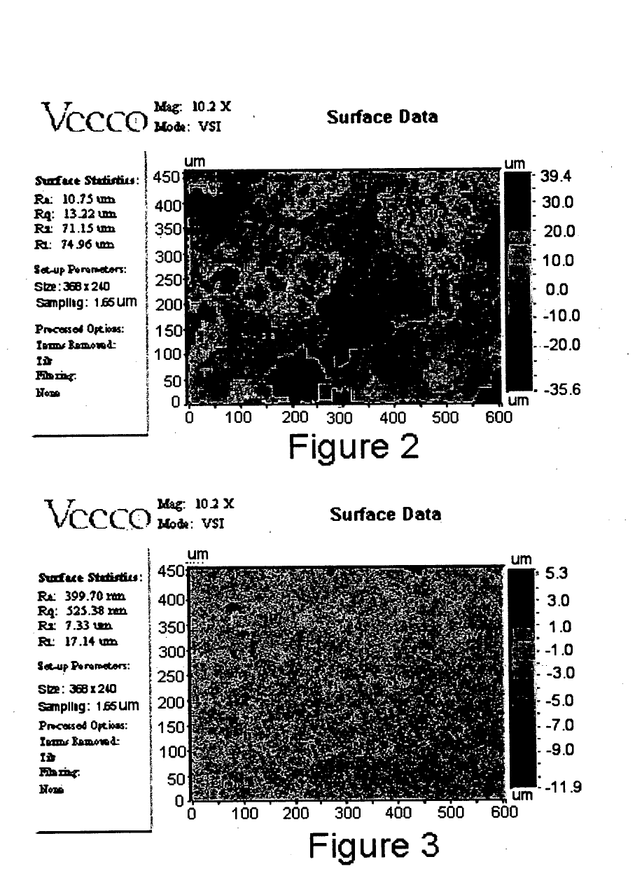

In the example shown in FIG. 1, the surface of a stainless steel SS316L sample was roughened using a water jet. The water pressure was 30,000 to 50,000 psi. The WYKO surface profiler results are shown in FIG. 2. They WYKO surface profile results for the smooth stainless steel sample, prior to roughening with the water jet, are shown in FIG. 3.

As used in FIGS. 2 and 3, the roughness relates to the closely spaced irregularities left on the surface from a treatment or production process. Ra is the average roughness. This averages all heights in a defined length or area. It is the mean height as calculated over the entire measured array.

Rq is the root mean square roughness. This is root mean square average of the measured height deviations taken over the entire measured array and measured from the mean linear surface. Then root mean square roughness is obtained by squaring each value over the evaluation length and then taking the square root of the mean.

Rq is the maximum height profile. This is the vertical distance between the highest and the lowest points of the surface within the evaluation length. It is the maximum peak to valley height of the profile calculated over the entire measured array.

Rz is the average maximum height of the profile. This is the average of the successive values of Rti calculated over the entire measured array. Rti is the vertical distance between the highest and lowest points in the profile.

For the roughened stainless steel sample, the norm value for this sample was found to be 16.78 billion cubic microns per square inch. The norm value was calculated by the placement of a smooth sheet on top of the roughened sample and determining the volume of the fluid held therebetween. The surface area index, which is the integrated area of one peak, for this sample was found to be 5.04077. This is approximately 80 times more surface area index than a smooth sample, which has a surface area index of 1. In accordance with one aspect of the present invention, the roughened surface has a surface area index in the range of 1 to 10.

The peak spacing in the x-direction or stylus xPc was 4.86 millimeters. The peak spacing in the y-direction or stylus yPc is found to be 7.69 millimeters. These peak spacings were the average of the entire sample. In accordance with one aspect of the present invention, the roughened surface has a peak spacing in the range of 1 millimeter to 10 millimeters.

It is desirable to have the average roughness or Ra to be between 10 and 15. This gives an average volume increase of 10 to 15 times that of a flat plate.

The roughened water jet sample showed very low contact angles in the range of <5 degrees defining them to be super hydrophilic. These low values are thought to be created by the combination of two levels of roughness, at the nano-scale of roughness and the micro-scale of roughness.

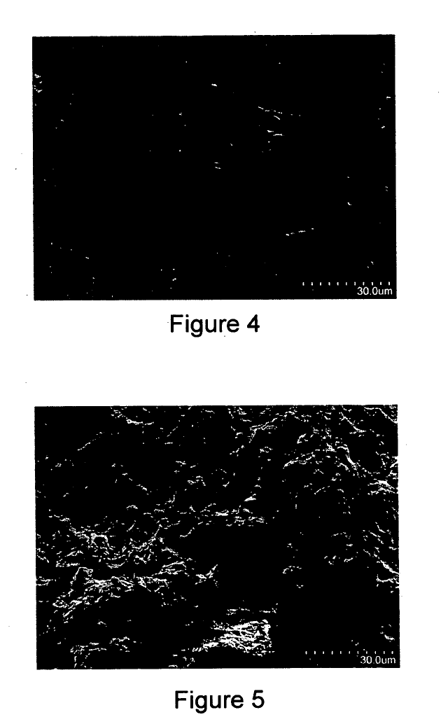

FIG. 4 is a scanning electron microscope, SEM, view of the smooth stainless steel sampling before roughening magnified 1000 times. FIG. 5 is an SEM view of the same stainless steel sample roughened with a water jet. This view is also magnified 1000 times. As can be seen, in each view, the scale is 30.0 micrometers. Each line on the scale represents 3 micrometers.

By roughing the surface utilizing the water jet technology, the super hydrophilic surface is created. As best seen in FIG. 5, the roughness is such that a water droplet has nowhere to adhere. Thus, the water droplet spreads over the surface. Because the roughening process was done using a water jet process, it follows that the roughened surface is free of contaminants which, if present, can negatively affect fuel cell performance and durability considerably. Further, the hydrophilic surface should be kept free from contamination in order to maintain its hydrophilicity.

Accordingly, the super hydrophilic surface improves water management in the fuel cell stack. Further, the super hydrophilic surface enhances the low power stability of the stacks. Also, the roughening of the surface further improves fuel cell performance and improves the durability of the fuel cell stacks. Additionally, the surface modification or roughening also improves material degradation properties. Further, it protects all MEA materials from contamination.

Once the surface of the bipolar plate has been roughened, gold may be vapor deposited on the roughened surface. By way of example, the application of 10 nanometers of gold by vapor deposition reduces electrical contact resistance between the diffusion paper and the bipolar plate surface.

The specific example identified above was for use of a water jet on a stainless steel sample. It will be appreciated that the water jet technology may also be used for other surfaces of a bipolar plate, including polymer surfaces. For a polymer surface, however, it is likely that lower water jet operating pressures will be required to produce the hydrophilic surface. In any event, it will be appreciated that the water jet pressure can be optimized for the material used on the plate to produce the hydrophilic surface.

It will be appreciated that other techniques may be used to roughen the surface of the bipolar plate in addition to water jet blasting. These include, without limitation, grit blasting and/or dry ice blasting.

It has been found that, when using grit blasting and/or dry ice blasting, the surface created on the plates may not wick water well and appear super hydrophobic with a contact angle>130 degrees. Although the hydrophobic surface may start wetting after an initial wetting of these rough surfaces, particularly at low power conditions when stack humidity is at its greatest, a wet film on the roughened surface causes the next water droplet from the catalyst layer to quickly spread out along the channel surface, enabling the water to be removed at low gas velocity.

Thus, these surfaces require initial wetting after the surfaces are roughened. These surfaces have a contact angle greater than 90 degrees. The super hydrophobic surfaces repel water, reducing retention of water on the surface. This repulsion of water enhances mass transport of the oxygen, hydrogen and water within the fuel cell, thus enhancing the water management capability of the fuel cell.

The invention has been described in an illustrative manner, and it is to be understood that terminology which has been used is intended to be in the nature of words of description, rather than of limitation. Many modifications and variations of the present invention in light of the above teachings.

What is claimed is:

1. A method of modifying the surface of a fuel cell element, comprising:
providing a fuel cell element having a surface formed thereon; and
roughening the surface of the fuel cell element to create either a super hydrophilic or a super hydrophobic surface thereon.

2. The invention according to claim 1, wherein the roughening step comprising a blasting operation.

3. The invention according to claim 2, wherein the blasting operation comprises water jet blasting.

4. The invention according to claim 3, wherein the water jet blasting creates a super hydrophilic surface on the surface of the fuel cell element.

5. The invention according to claim 1, wherein the roughening step comprises a technique selected from the group consisting of grit blasting, dry ice blasting, and combinations thereof.

6. The invention according to claim 5, wherein the roughening step creates a super hydrophobic surface on the surface of the fuel cell element.

7. The invention according to claim 5 further comprising wetting the super hydrophobic surface.

8. The invention according to claim 1, wherein the fuel cell element comprises a bipolar plate.

9. The invention according to claim 1, wherein the hydrophilic surface has a contact angle of less than 5 degrees.

10. The invention according to claim 1, wherein the hydrophobic surface has a contact angle of greater than 130 degrees.

11. The invention according to claim 1, wherein the roughened surface has an average roughness in the range of 10 to 15.

12. The invention according to claim 1, wherein the roughened surface has a surface area index in the range of 1 to 10.

13. The invention according to claim 1, wherein the roughened surface has a peak spacing in the range of 1 millimeter to 10 millimeters.

14. The invention according to claim 1, further comprising applying a layer of gold to the roughened surface of the fuel cell element.

15. A fuel cell system, comprising:
a fuel cell element having a surface formed thereon;
wherein the surface of the fuel cell element has been roughened to create either a super hydrophilic or a super hydrophobic surface thereon.

16. The invention according to claim 15, wherein the roughening comprises a blasting operation.

17. The invention according to claim 16, wherein the blasting operation comprises water jet blasting.

18. The invention according to claim 17, wherein the water jet blasting creates a super hydrophilic surface on the surface of the fuel cell element.

19. The invention according to claim 15, wherein the roughening comprises a technique selected from the group consisting of grit blasting, dry ice blasting, and combinations thereof.

20. The invention according to claim 19, wherein the roughening creates a super hydrophobic surface on the surface of the fuel cell element.

21. The invention according to claim 15, wherein the fuel cell element comprises a bipolar plate.

22. The invention according to claim 15, wherein the hydrophilic surface has a contact angle of less than 5 degrees.

23. The invention according to claim 15, wherein the hydrophobic surface has a contact angle of greater than 130 degrees.

24. The invention according to claim 15, wherein the roughened surface has an average roughness in the range of 10 to 15.

25. The invention according to claim 15, wherein the roughened surface has a surface area index in the range of 1 to 10.

26. The invention according to claim 15, wherein the roughened surface has a peak spacing in the range of 1 millimeter to 10 millimeters.

27. The invention according to claim 15, wherein a layer of gold is disposed on the roughened surface of the fuel cell element.
